(19) United States
(12) Patent Application Publication
(10) Pub. No.: US 2010/0045687 A1
(43) Pub. Date: Feb. 25, 2010

(54) OVERLAP IN SUCCESSIVE TRANSFERS OF VIDEO DATA TO MINIMIZE MEMORY TRAFFIC

(75) Inventors: Ajit Deepak Gupte, Bangalore (IN); Prasenjit Basu, Bangalore (IN)

Correspondence Address: TEXAS INSTRUMENTS INCORPORATED, P O BOX 655474, M/S 3999, DALLAS, TX, 75265, US

(73) Assignee: Texas Instruments Inc.

(21) Appl. No.: 12/197,337

(22) Filed: Aug. 25, 2008

(51) Int. Cl. G06F 13/00; G06F 12/00

(52) U.S. Cl. 345/537; 711/105; 711/E12.001

(57) ABSTRACT

A method, system, and apparatus of overlap in successive transfers of video data to minimize memory traffic are disclosed. In one embodiment, a method includes identifying a reusable portion of a preexisting video data in an on-chip memory that corresponds to an overlapping video data in an off-chip memory, preserving the reusable portion of the preexisting video data in the on-chip memory in a reserved part of the on-chip memory, determining a non-overlapping video data in the off-chip memory, wherein the non-overlapping video data excludes the overlapping video data in the off-chip memory, defining a subsection of the non-overlapping video data, accessing the subsection of the non-overlapping video data, and selectively storing the subsection in the on-chip memory, such that the reusable portion of the preexisting video data of the on-chip memory is preserved in the reserved part of the on-chip memory.

### FIELD OF TECHNOLOGY

This disclosure relates generally to an enterprise method, a technical field of software and/or hardware technology and, in one example embodiment to overlap in successive transfers of video data to minimize memory traffic.

### BACKGROUND

A transfer of a video data may require determining the video data to move between an on-chip memory (e.g., a buffer, a cache, etc.) and an off-chip memory (e.g., a DRAM, an SDRAM, an SRAM, a hard drive, a cache). A bounding box, which may be comprised of the video data of a reference region, may determine the video data of the transfer. The bounding box may include an extraneous video data not used by the video application. The bounding box may further include an overlapping video data contained in a prior bounding box. The transfer of the extraneous video data and/or the overlapping video data may require a system resource (e.g., a bandwidth, a power, the on-chip memory, the off-chip memory, a processor, etc.), and a delay and/or an inefficiency (e.g., a read and/or write time, a processor time, a loss of useful information, etc.) may occur as a result.

A cache memory (e.g., the DRAM, the SDRAM, the SRAM, the on-chip memory, the off-chip memory, etc.) may be involved with transferring the video data. The cache memory may be comprised of a line of the video data with a start and/or an end point that may not correlate with a boundary of the overlapping video data. As a result, a mixed line of the cache memory may be comprised of both a non-overlapping video data and the overlapping video data. A useful video data may be extracted from the mixed line of the cache memory, which may require an additional hardware (e.g., a cache processor) and/or an additional instruction from software (e.g., a cache software). In addition, the mixed line of cache may be discarded, which may cause a useful information to be lost. The use of the cache to transfer the overlapping video data may also require the system resource, and a further delay and/or further inefficiency (e.g., the bandwidth, the power, the on-chip memory, the off-chip memory, the processor, etc.) may result.

### SUMMARY

A method, system, and apparatus of an overlap in successive transfers of video data to minimize memory traffic are disclosed. In one aspect, a method includes identifying a reusable portion of a preexisting video data in an on-chip memory that corresponds to an overlapping video data in an off-chip memory, preserving the reusable portion of the preexisting video data in the on-chip memory in a reserved part of the on-chip memory, determining a non-overlapping video data (e.g., the non-overlapping video data may exclude the overlapping video data in the off-chip memory) in the off-chip memory, defining a subsection of the non-overlapping video data, accessing the subsection of the non-overlapping video data, and selectively storing the subsection in the on-chip memory (e.g., such that the reusable portion of the preexisting video data of the on-chip memory may be preserved in the reserved part of the on-chip memory).

The method may include mapping a coordinate of the reusable portion of the preexisting video data in the on-chip memory to correspond to the coordinate of the overlapping video data in the off-chip memory. The method may also include identifying a new reusable portion of a current video data in the on-chip memory that corresponds to an additional overlapping video data in the off-chip memory. In addition, the method may include mapping the coordinate of the subsection selectively stored in the on-chip memory to correspond to the coordinate of the subsection in the off-chip memory.

The subsection of the non-overlapping video data in the off-chip memory may include a rectangular region of the non-overlapping video data. The subsection of a transferable video data may be selectively stored in an unreserved part of the on-chip memory (e.g., such that a coordinate of the subsection corresponds to a coordinate of the preexisting video data preserved in the reserved part of the on-chip memory).

A continuing part of the selectively stored subsection that extends past a boundary may be selectively stored at a beginning of an opposite boundary. The overlapping video data in the off-chip memory may be the same as the portion of the preexisting video data in the on-chip memory. The method may include processing a current video data stored in the on-chip memory in a video application. The video application may be a motion compensation module and/or a motion estimation module.

A reference region in the off-chip memory may include the overlapping video data and/or the non-overlapping video data. A motion compensation window may include the preexisting video data in the on-chip memory and a next sequential motion compensation window may include the reference region in the off-chip memory. The preexisting video data in an on-chip memory may include a selected portion of the motion compensation window from a prior line of motion compensation windows.

The preexisting video data in an on-chip memory may include a selected portion of the motion compensation window from a prior line of reference regions. The preexisting video data may also include additional data from the prior line of reference regions that were never used for the prior line of motion compensation windows. The identification of the reusable portion of the preexisting video data in an on-chip memory may be comprised of identifying a reusable portion of the prior motion compensation window and/or identifying a reusable selected portion of a reference region from a prior line of reference regions.

In another aspect, the method may include identifying a reusable portion of a preexisting video data in an on-chip memory that corresponds to an overlapping video data in an off-chip memory, preserving the reusable portion of the preexisting video data in the on-chip memory in a reserved part of the on-chip memory, determining a non-overlapping video data in the off-chip memory, wherein the non-overlapping video data excludes the overlapping video data in the off-chip memory, defining a subsection of the non-overlapping video data, accessing a subsection of the non-overlapping video data, selectively storing the subsection in the on-chip memory, such that the reusable portion of the preexisting video data of the on-chip memory is preserved in the reserved part of the on-chip memory, and identifying a new reusable portion of an other video data in the on-chip memory that corresponds to an additional overlapping video data in the off-chip memory.

The method may include preserving the new reusable portion of the other video data in the on-chip memory in a new reserved part of the on-chip memory. The method may determine an additional non-overlapping video data in the off-chip memory. The additional non-overlapping video data may exclude a new overlapping video data in the off-chip memory. The method may define an additional subsection of a new non-overlapping video data. The method may access the additional subsection of the new non-overlapping video data. The method may selectively store the additional subsection in the on-chip memory, (e.g., such that the new reusable portion of the other video data of the on-chip memory may be preserved in the new reserved part of the on-chip memory).

The method may include mapping a coordinate of the new reusable portion of the other video data in the on-chip memory to correspond to the coordinate of the overlapping video data in the off-chip memory. A continuing part of the selectively stored subsection that extends past a boundary may be selectively stored at a beginning of an opposite boundary. The method may include processing a current video data stored in the on-chip memory in a video application (e.g., the video application may be a motion compensation module and/or a motion estimation module).

In yet another aspect, a system includes a processor communicatively coupled to a memory and a storage device, and a video application module associated with the processor to identify a reusable portion of a preexisting video data in an on-chip memory that corresponds to an overlapping video data in an off-chip memory, to preserve the reusable portion of the preexisting video data in the on-chip memory in a reserved part of the on-chip memory, to determine a non-overlapping video data in the off-chip memory, wherein non-overlapping video data excludes the overlapping video data in the off-chip memory, to define a subsection of the non-overlapping video data, to access a subsection of the non-overlapping video data, and to selectively store the subsection in the on-chip memory, such that the reusable portion of the preexisting video data of the on-chip memory is preserved in the reserved part of the on-chip memory.

The video application module may include a motion compensation module and/or a motion estimation module.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is a systematic view illustrating an on-chip memory that may include a reusable portion of preexisting video data that may be used to construct a video data for next frame, according to one embodiment.

FIG. 1B-E is the systematic view illustrating the procedure of identifying a non-overlapping video data, defining the subsection of overlapping video data, accessing the subsection and selectively storing the subsection of the non-overlapping video data in an on-chip memory, according to one embodiment.

FIG. 2 is a systematic view illustrating mapping a coordinate of the reusable portion of the preexisting video data to correspond to the overlapping video data, according to one embodiment.

FIG. 3A-B illustrates mapping of coordinates of selectively stored sub-section from an off-chip memory to an on-chip memory, according to one embodiment.

FIG. 4A-D is the systematic view illustrating the process of identifying a reusable portion of video data along with the additional overlapping video data, accessing the additional subsection and selectively storing the additional subsection of the non-overlapping video data in the on-chip memory, according to one embodiment.

FIG. 5 is a systematic view illustrating a preexisting video data in an on-chip memory that can be used to construct the next set of video reference frames, according to one embodiment.

FIG. 6 is a system view illustrating the video application module communicating with the processor to minimize memory traffic between the on-chip memory and the off-chip memory, according to one embodiment.

FIG. 7A is a process flow of processing a current video data stored in an on-chip memory to apply the existing data to construct the next video data, according to one embodiment.

FIG. 7B is a continuation of the process flow of FIG. 7A, illustrating additional processes, according to one embodiment.

FIG. 8A is the process flow of identifying and processing the reusable video data stored in the on-chip memory, according to one embodiment.

FIG. 8B is a continuation of the process flow of FIG. 8A illustrating additional process, according to one embodiment.

FIG. 9 is a systematic view of overlapping of a motion compensation window 900 with a next sequential motion compensation window and with the selected portion of a prior line of reference regions, according to one embodiment.

Other features of the present embodiments will be apparent from the accompanying drawings and from the detailed description that follows.

### DETAILED DESCRIPTION

A method, system, and apparatus to utilize overlap in successive transfers of video data to minimize memory traffic are disclosed. Although the present embodiments have been described with reference to specific example embodiments, it will be evident that various modifications and changes may be made to these embodiments without departing from the broader spirit and scope of the various embodiments.

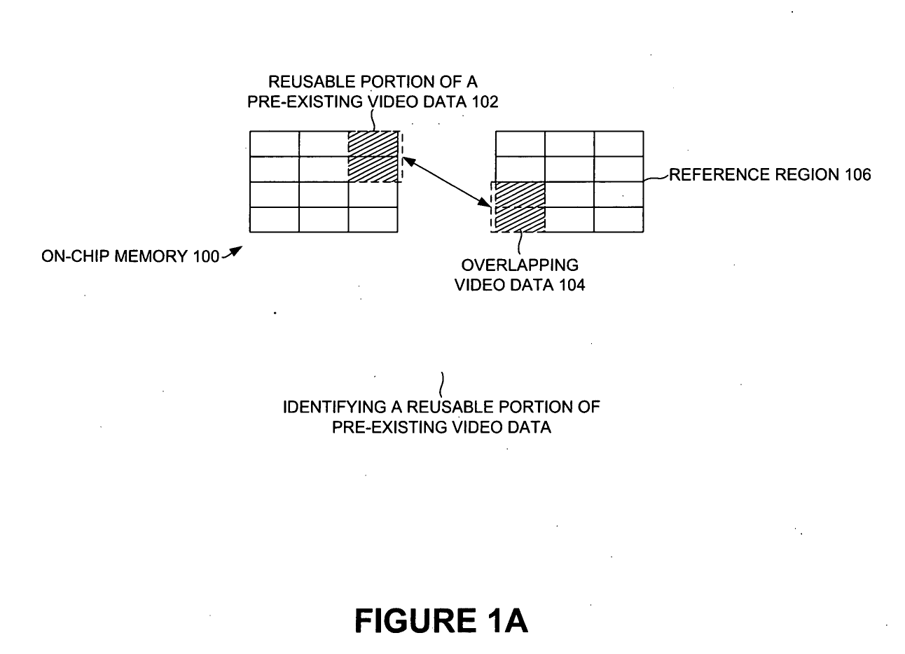

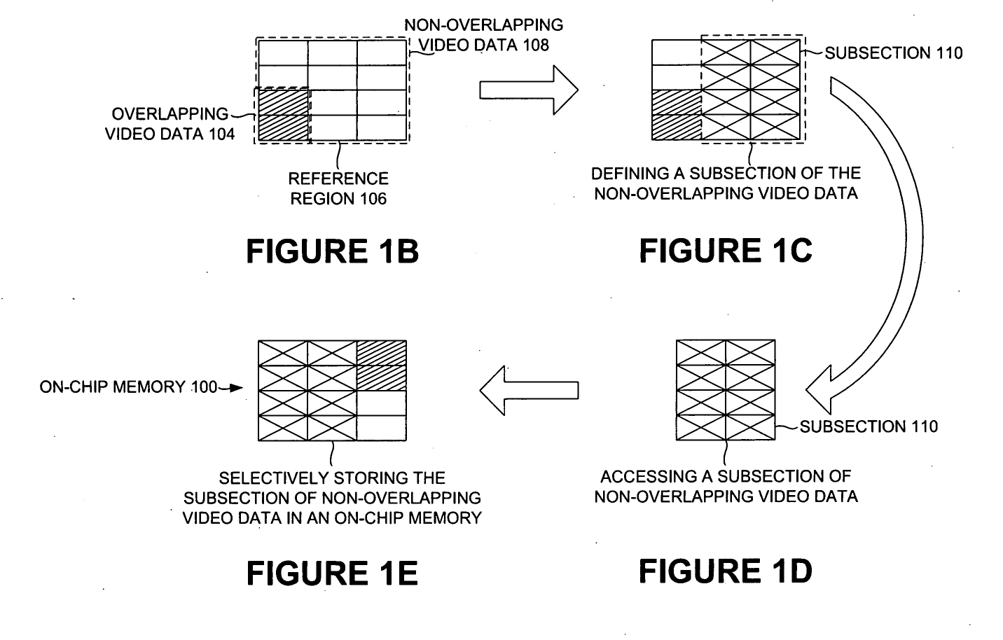

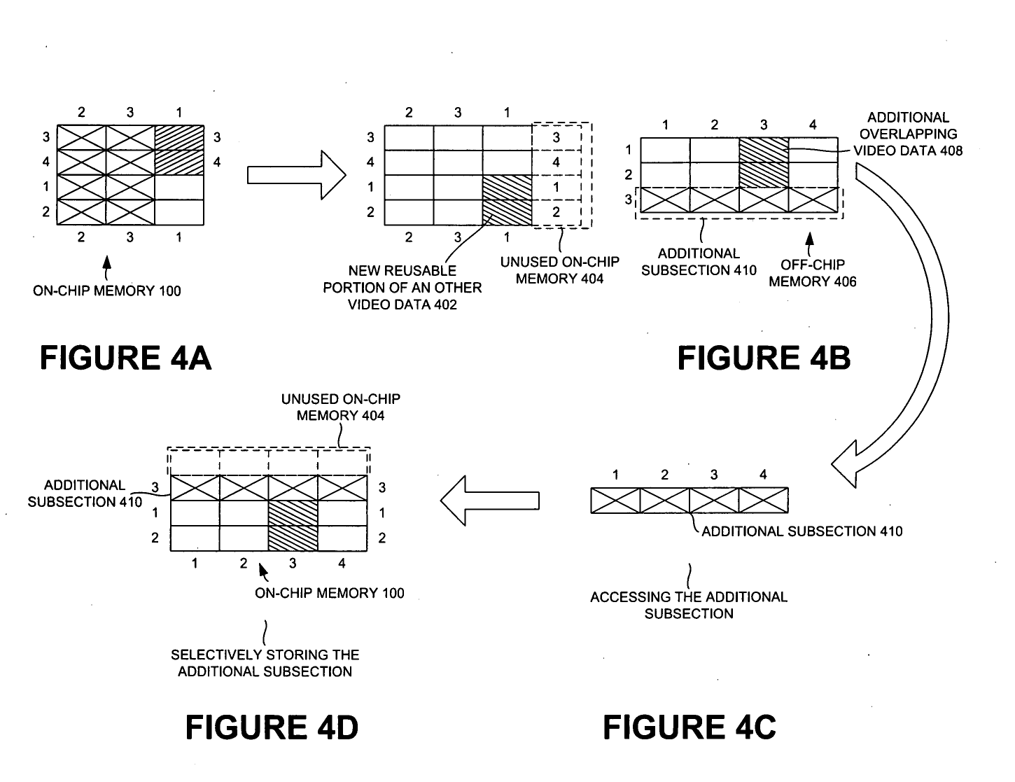

In one embodiment, a method includes identifying a reusable portion of a preexisting video data (e.g., the reusable portion of the preexisting video data 102 of FIG. 1A) in an on-chip memory (e.g., the on-chip memory 100 of FIG. 1A) that corresponds to an overlapping video data (e.g., the overlapping video data 104 of FIG. 1A) in an off-chip memory (e.g., the off-chip memory 406 of FIG. 4), preserving the reusable portion of the preexisting video data 102 in the on-chip memory 100 in a reserved part of the on-chip memory 100, determining a non-overlapping video data (e.g., the non-overlapping video data 108 of FIG. 1B) (e.g., the non-overlapping video data 108 may exclude the overlapping video data 104 in the off-chip memory 406) in the off-chip memory 406, (e.g., the non-overlapping video data excludes the overlapping video data 104 in the off-chip memory 406), defining a subsection of the non-overlapping video data 108, accessing the subsection of the non-overlapping video data 108, and selectively storing the subsection in the on-chip memory 100, such that the reusable portion of the preexisting video data 102 of the on-chip memory 100 is preserved in the reserved part of the on-chip memory 100.

In another embodiment, a method includes identifying a reusable portion of a preexisting video data (e.g., the reusable portion of the preexisting video data 102 of FIG. 1A) in an on-chip memory (e.g., the on-chip memory 100 of FIG. 1A) that corresponds to an overlapping video data (e.g., the overlapping video data 104 of FIG. 1A) in an off-chip memory (e.g., the off-chip memory 406 of FIG. 4), preserving the reusable portion of the preexisting video data 102 in the on-chip memory 100 in a reserved part of the on-chip memory 100, determining a non-overlapping video data (e.g., the non-overlapping video data 108 of FIG. 1B) (e.g., the non-overlapping video data 108 may exclude the overlapping video data 104 in the off-chip memory 406) in the off-chip memory 406, defining a subsection of the non-overlapping video data 108, accessing the subsection of the non-overlapping video data 108, selectively storing the subsection in the on-chip memory 100, (e.g., such that the reusable portion of the preexisting video data 102 of the on-chip memory 100 is preserved in the reserved part of the on-chip memory 100), and identifying a new reusable portion of an other video data in the on-chip memory 100 that corresponds to an additional overlapping video data in the off-chip memory 406.

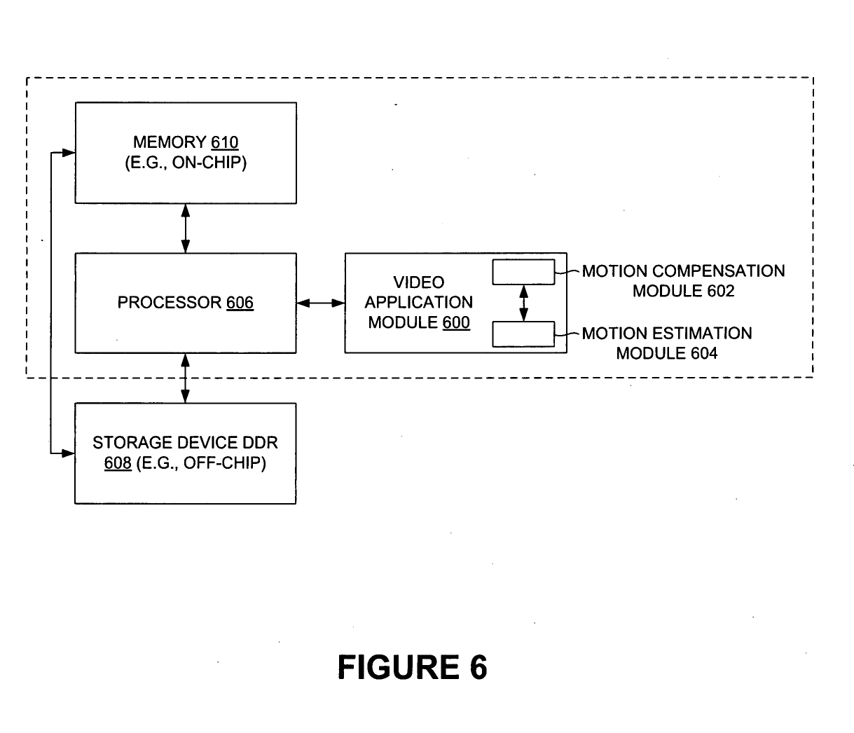

In yet another embodiment, a system includes a processor (e.g., the processor 606 of FIG. 6) communicatively coupled to a memory (e.g., the memory 610 of FIG. 6) and a storage device (e.g., the storage device 608 of FIG. 6), and a video application module (e.g., the video application module 600 of FIG. 6) associated with the processor 606 to identify a reusable portion of a preexisting video data (e.g., the reusable portion of the preexisting video data 102 of FIG. 1A) in an on-chip memory (e.g., the on-chip memory 100 of FIG. 1) that corresponds to an overlapping video data (e.g., the overlapping video data 104 of FIG. 1A) in an off-chip memory (e.g., the off-chip memory 406 of FIG. 4), to preserve the reusable portion of the preexisting video data 102 in the on-chip memory 100 in a reserved part of the on-chip memory 100, to determine a non-overlapping video data (e.g., the non-overlapping video data 108 of FIG. 1B) (e.g., non-overlapping video data 108 excludes the overlapping video data 104 in the off-chip memory 406 in the off-chip memory 406, to define a subsection of the non-overlapping video data 108, to access a subsection of the non-overlapping video data 108, and to selectively store the subsection in the on-chip memory 100 (e.g., such that the reusable portion of the preexisting video data 102 of the on-chip memory 100 is preserved in the reserved part of the on-chip memory 100).

FIG. 1A is a systematic view illustrating an on-chip memory that may include a reusable portion of preexisting video data that may be used to construct a video data for next reference video data, according to one embodiment. Particularly, FIG. 1 illustrates an on-chip memory 100, a reusable portion of preexisting video data 102, an overlapping video data 104, and a reference region 106, according to one embodiment.

The on-chip memory 100 may be a storage device (e.g., the buffer, the cache memory, etc.) that may be used to process (e.g., store, retrieve, etc.) the data (e.g., video data, etc.) which may be used by the processor 606 for processing (e.g., compression, estimation, decompression, etc.) the data. The reusable portion of the preexisting video data 102 may be part of data (e.g., a part of the bounding box) that may be residing in the on-chip memory 100 (e.g., the buffer, etc.) that may correspond to the overlapping video data 104 in a off-chip memory (e.g., the off-chip memory 406 of FIG. 4) (e.g., DRAM, SDRAM, SRAM, hard drive, cache, etc.). The reusable portion of the preexisting video data 102 may be used to construct the next video reference data without copying that part of the data from the off-chip memory 406.

The overlapping video data 104 may be a video data in the storage device (e.g., in the off-chip memory 406) that may correspond to the portion of the preexisting video data (e.g., a portion of the bounding box) in the other storage device (e.g., the on-chip memory 100). The reference region 106 may be an area in the storage device (e.g., the off-chip memory 406) that may include data frames (e.g., video frames etc.) comprised of the overlapping video data 104 and the non-overlapping video data 108 (may be portion of bounding box that may be used as part of constructing a next set of reference data).

In an example embodiment, the on-chip memory 100 may include the reusable portion of preexisting video data 102. The reference region 106 may include the overlapping video data 104 and the non-overlapping video data 108. The video data on the on-chip memory 100 may include the reusable portion of preexisting video data 102 that may be required for constructing next video data.

In one embodiment, the reusable portion of the preexisting video data 102 in the on-chip memory 100 may be identified that may correspond to the overlapping video data 104 in an off-chip memory (e.g., the off-chip memory 406 of FIG. 4). The reusable portion of the preexisting video data 102 in the on-chip memory 100 may be preserved in a reserved part of the on-chip memory 100.

The reusable portion of a preexisting video data 102 in the on-chip memory 100 may be identified that may correspond to the overlapping video data 104 in the off-chip memory 406. The reusable portion of the preexisting video data 102 in the on-chip memory 100 may be preserved in a reserved part of the on-chip memory 100.

FIG. 1B-E is the systematic view illustrating the procedure of identifying a non-overlapping video data, defining the subsection of overlapping video data, accessing the subsection and selectively storing the subsection of the non-overlapping video data in an on-chip memory, according to one embodiment. Particularly, FIG. 1B-E illustrates the on-chip memory 100, the overlapping video data 104, the reference region 106, and a non-overlapping video data 108, according to one embodiment.

The non-overlapping video data 108 may be the data frame (e.g., video data frame etc.) that may be residing in the storage device (e.g., in the off-chip memory 406) that may exclude the overlapping video data in the off-chip memory 406.

In an example embodiment, FIG. 1B may illustrate a reference region 106 including the overlapping video data 104, and the non-overlapping video data 108. FIG. 1C may be the next step of FIG. 1B that may define the sub-section of the non-overlapping video data 108 and the overlapping video data 104. FIG. 1D may be the next step of FIG. 1C that may access the sub-section of non-overlapping video data in the on-chip memory 100. FIG. 1E may be the next step of the FIG. 1D that may selectively store the sub-section of non-overlapping video data in the on-chip memory 100.

In one embodiment, the non-overlapping video data 108 in the off-chip memory 406 may be determined. The non-overlapping video data 108 may exclude the overlapping video data 104 in the off-chip memory 406. A subsection of the non-overlapping video data 108 may be defined. The subsection of the non-overlapping video data 108 may be accessed. The subsection in the on-chip memory 100 may be selectively stored (e.g., the reusable portion of the preexisting video data 102 of the on-chip memory 100 may be preserved in the reserved part of the on-chip memory 100).

The subsection of the non-overlapping video data 108 in the off-chip memory 406 may be comprised of a rectangular region of the non-overlapping video data 108. The subsection of a transferable video data may be selectively stored in an unreserved part of the on-chip memory 100 (e.g., a coordinate of the subsection may correspond to a coordinate of the preexisting video data 500 preserved in the reserved part of the on-chip memory 100). A continuing part of the selectively stored subsection that may extend past a boundary is selectively stored at a beginning of an opposite boundary.

The non-overlapping video data 108 in the off-chip memory 406 may be determined. The non-overlapping video data 108 may exclude the overlapping video data 104 in the off-chip memory 406. A subsection of the non-overlapping video data 108 may be defined. The subsection of the non-overlapping video data 108 may be accessed. The subsection in the on-chip memory 100 may be selectively stored (e.g., the reusable portion of the preexisting video data 102 of the on-chip memory 100 may be preserved in the reserved part of the on-chip memory 100).

The non-overlapping video data 108 may exclude the overlapping video data 104 in the off-chip memory 406, to define a subsection of the non-overlapping video data 108, to access the subsection of the non-overlapping video data 108, and to selectively store the subsection in the on-chip memory 100 (e.g., the reusable portion of the preexisting video data 102 of the on-chip memory 100 may be preserved in the reserved part of the on-chip memory 100).

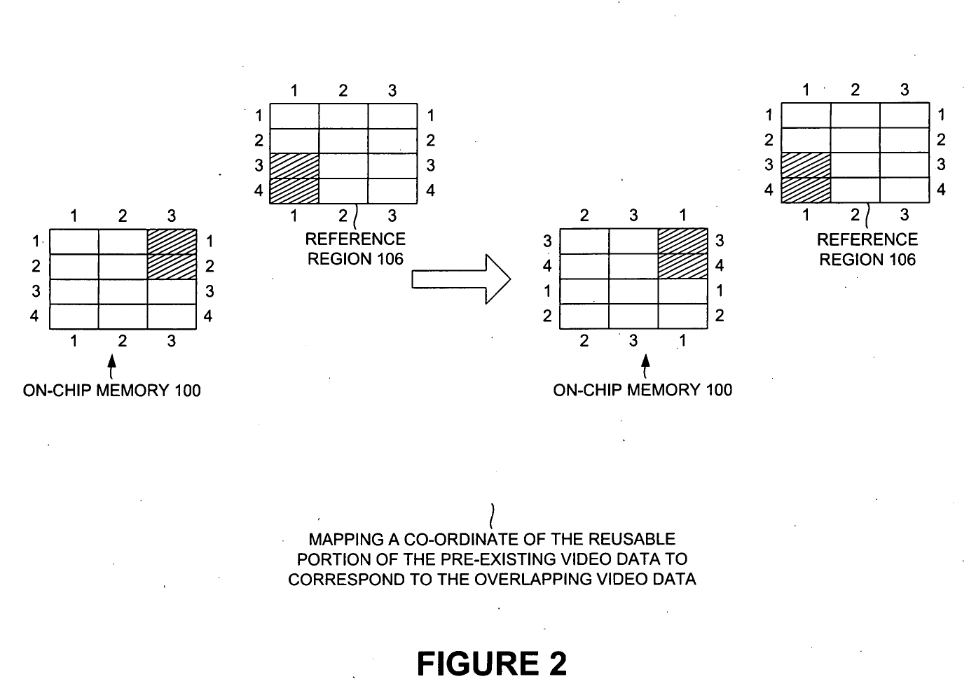

FIG. 2 is a systematic view illustrating mapping a coordinate of the reusable portion of the preexisting video data to correspond to the overlapping video data, according to one embodiment. Particularly, FIG. 2 may illustrate the on-chip memory, and the reference region 106, according to one embodiment.

In an example embodiment, the on-chip memory 100 and the reference region 106 may include the reusable portion of the preexisting video data 102. The re-mapped on-chip memory and the reference region 106 may include the overlapping video data.

In one embodiment, a coordinate of the reusable portion of the preexisting video data 102 in the on-chip memory 100 may be mapped to correspond to the coordinate of the overlapping video data 104 in the off-chip memory 406.

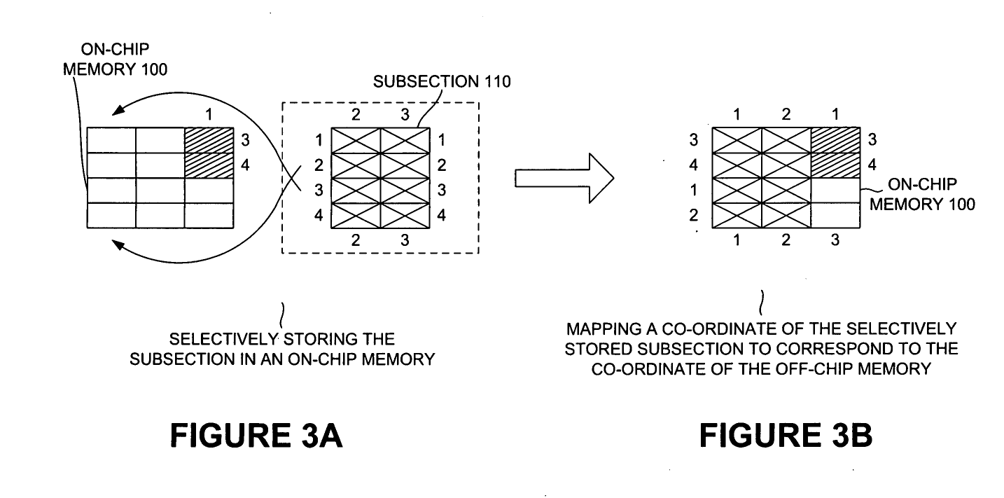

FIG. 3A-B illustrates mapping of coordinates of selectively stored sub-section from an off-chip memory to an on-chip memory, according to one embodiment.

In an example embodiment, the subsection in an on-chip memory 100 may be selectively stored. Coordinate of selectively stored subsection may be mapped to correspond to the coordinate of the off-chip memory 406.

In one embodiment, the coordinate of the subsection selectively stored in the on-chip memory 100 (e.g., as illustrated in FIG. 3A) may be mapped to correspond to the coordinate of the subsection in the off-chip memory 406 (e.g., as illustrated in FIG. 3B).

FIG. 4A-D is the systematic view illustrating the process of identifying a reusable portion of video data along with the additional overlapping video data, accessing the additional subsection and selectively storing the additional subsection of the non-overlapping video data in the on-chip memory, according to one embodiment. Particularly, FIG. 4A-D illustrates an on-chip memory 100, a new reusable portion of an other video data 402, an unused on-chip memory 404, an off-chip memory 406, an additional overlapping video data 408, and an additional subsection 410, according to one embodiment.

The new reusable portion of an other video data 402 may be the data (e.g., the current video data) that may reside in the memory location (e.g., the on-chip memory 100) that may correspond to the additional overlapping video data 408 in the other memory location (e.g., the off-chip memory 406). The unused on-chip memory 404 may be the portion of the memory location (e.g., the storage device 608) which can be used for some other purpose (e.g., overlapping the data). The off-chip memory 406 may be a storage device that may be used to process (e.g., store, etc.) the data (e.g., the video data, etc.) that may be used by the processor for processing (e.g., compression, estimation, de-compression, etc.) of video data.

The additional overlapping video data 408, may be the data (e.g., the video data frame) residing in the portion of storage device 608 (e.g., the off-chip memory) that may correspond to the new reusable portion of the data (e.g., current video data) in the off-chip memory 406. The additional subsection 410 may be the portion of the memory 610 (e.g., the on-chip memory 100) that may be accessed for the new non-overlapping video data and may be selectively stored in the on-chip memory 100.

In an example embodiment, the on-chip memory 100 may illustrate coordinates that may be used to map to off-chip memory (e.g., the off-chip memory 406 of FIG. 4B). FIG. 4B may illustrate mapping of coordinates to an on-chip memory from the off-chip memory. FIG. 4C is a sectional view of additional subsection 410 illustrated in FIG. 4B. The additional subsection 410 is accessed that may include the coordinates 1, 2, 3, and 4. FIG. 4D illustrates selectively storing the additional subsection. The additional subsection 410 may be selectively stored in the on-chip memory 100. The unused on-chip memory 404, is represented on the on the on-chip memory.

In one embodiment, the new reusable portion of an other video data 402 in the on-chip memory 100 may be identified that may correspond to the additional overlapping video data 408 in the off-chip memory 406. The new reusable portion of the other video data 402 in the on-chip memory 100 may be preserved in a new reserved part of the on-chip memory 100. An additional non-overlapping video data in the off-chip memory 406 may be determined. The additional non-overlapping video data may exclude a new overlapping video data in the off-chip memory 406.

The additional subsection 410 of a new non-overlapping video data may be defined. The additional subsection 410 of the new non-overlapping video data may be accessed. The additional subsection 410 in the on-chip memory 100 may be selectively stored (e.g., the new reusable portion of the other video data of the on-chip memory 100 may be preserved in the new reserved part of the on-chip memory 100). A coordinate of the new reusable portion of the other video data 402 in the on-chip memory 100 may be mapped to correspond to the coordinate of the overlapping video data 104 in the off-chip memory 406.

A continuing part of the selectively stored subsection may be mapped that may extend past a boundary may be selectively stored at a beginning of an opposite boundary. The new reusable portion of a current video data in the on-chip memory 100 may be identified that may correspond to the additional overlapping video data 408 in the off-chip memory 406.

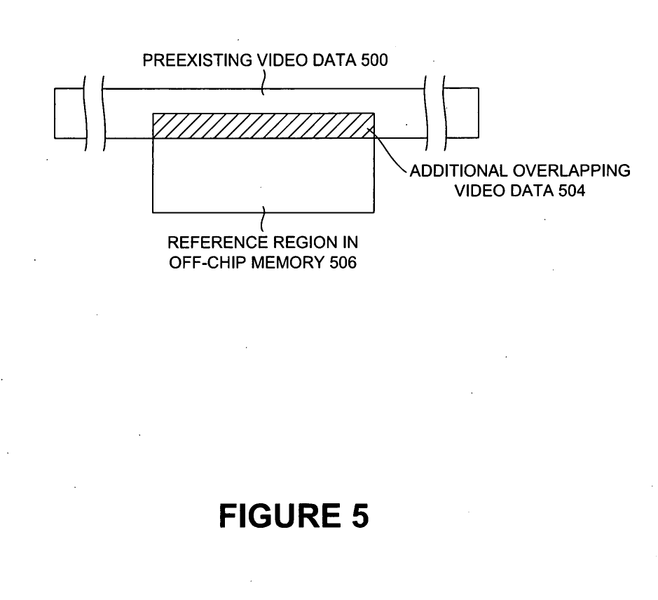

FIG. 5 is a systematic view illustrating a preexisting video data in an on-chip memory that can be used to construct the next set of frames, according to one embodiment. Particularly, FIG. 5 illustrates the overlapping video data 504, a preexisting video data 500, and a reference region in off-chip memory 506, according to one embodiment.

The preexisting video data 500 may be the existing video data in the on-chip memory (e.g., the cache memory, the buffer, etc.) that may correspond to the overlapping video data in an off-chip memory (e.g., SRAM, DRAM, SDRAM, etc.). The reference region in off-chip memory 506 may be the region located in the off-chip memory (e.g., SRAM, DRAM, SDRAM, etc.) that may include the overlapping video data 104 and the non-overlapping video data 108.

In an example embodiment, FIG. 5 illustrates the process that may be used to exploit the property of reusing the overlapping data in the on-chip memory 100. The consecutive overlapping location can be stored separately in a separate reserved location of the on-chip memory such that the whole set of the possible overlapping data may be used for constructing video data without much data transfer, hence reducing the bandwidth requirement to transfer data.

In one embodiment, the overlapping video data 104 in the off-chip memory 406 may be the same as the portion of the preexisting video data 500 in the on-chip memory 100. The reference region in the off-chip memory 504 may include the overlapping video data 104 and/or the non-overlapping video data 108. A motion compensation window may include the preexisting video data 500 in the on-chip memory 100 and a next sequential motion compensation window may include the reference region in the off-chip memory 504.

The preexisting video data 500 in the on-chip memory 100 may include of a selected portion of the motion compensation window from a prior line of motion compensation windows. The additional data is put into the preexisting video data that is not included in the prior line of motion compensation windows. The identification of the reusable portion of the preexisting video data in the on-chip memory may include identifying a reusable portion of the prior motion compensation window and identifying a reusable selected portion of the motion compensation window from a prior line of motion compensation windows.

FIG. 6 is the system view illustrating the video application module communicating with the processor to minimize memory traffic between the on-chip memory and the off-chip memory, according to one embodiment.

The video application module 600 may be a module that may enable the processor 606 to reduce the amount of bandwidth (e.g., the traffic, etc) for the data transfer between the memory 610 (e.g., the on-chip memory 100) and the storage device 608 (e.g., the off-chip memory 406) using motion estimation (e.g., maybe by using the motion estimation module 604) and motion compensation techniques (e.g., using the motion compensation module 602). The motion compensation module 602 may be used for describing a data (e.g., the video data, the picture, the image, etc) in terms of the transformation of a reference (e.g., may use the reference region 106) data (e.g., the video data, the picture, etc.) to the current data (e.g., the current video data, the picture, etc.).

The motion estimation module 604 may use to determine motion vectors (e.g., the transformed image from one 2D image to another image) from the adjacent frame (e.g., the reference frame) in the video sequence. The processor 606 may be the logic circuitry that may respond to and processes the instructions that may drive a data processing unit (may be the video application module 600). The storage device 608 (e.g., the off-chip memory 406) may be used to process (e.g., store, etc.) the data (e.g., the video data, etc.) that may be used by the processor for processing (e.g., compression, estimation, de-compression, etc.) the video data.

The memory 610 (e.g., the on-chip memory 100) may be a device (e.g., the buffer, the cache memory, etc.) which may be used to process (e.g., store, etc.) the data (e.g., the bounding box, the video data, etc.) that may be used by the processor 606 for processing (e.g., compression, estimation, de-compression, etc.) the video data.

In an example embodiment, the video application module 600 may include the motion estimation module 604 and the motion compensation module 602. The processor 606 may enable the video application module 600 for motion estimation and/or motion compensation. The memory 610 (e.g., the on-chip memory) and the storage device 608 (e.g., off-chip memory) may accessed by the processor 606 (e.g., for storing, retrieving the video data, etc.) for video data transfer.

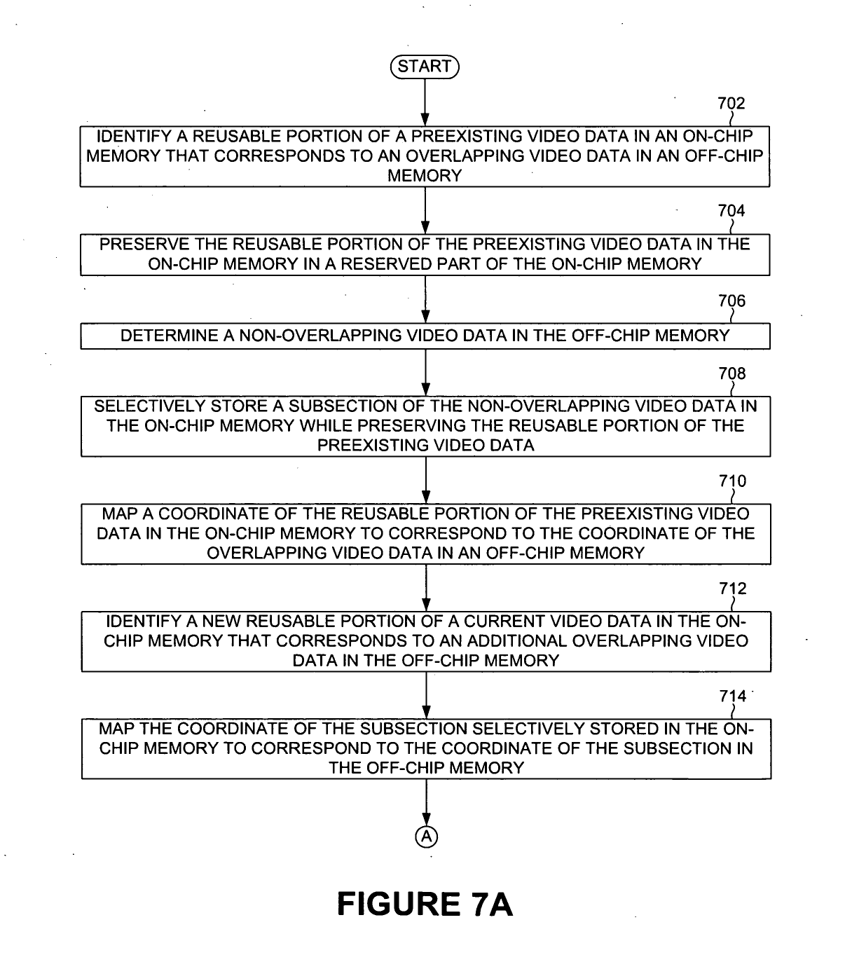

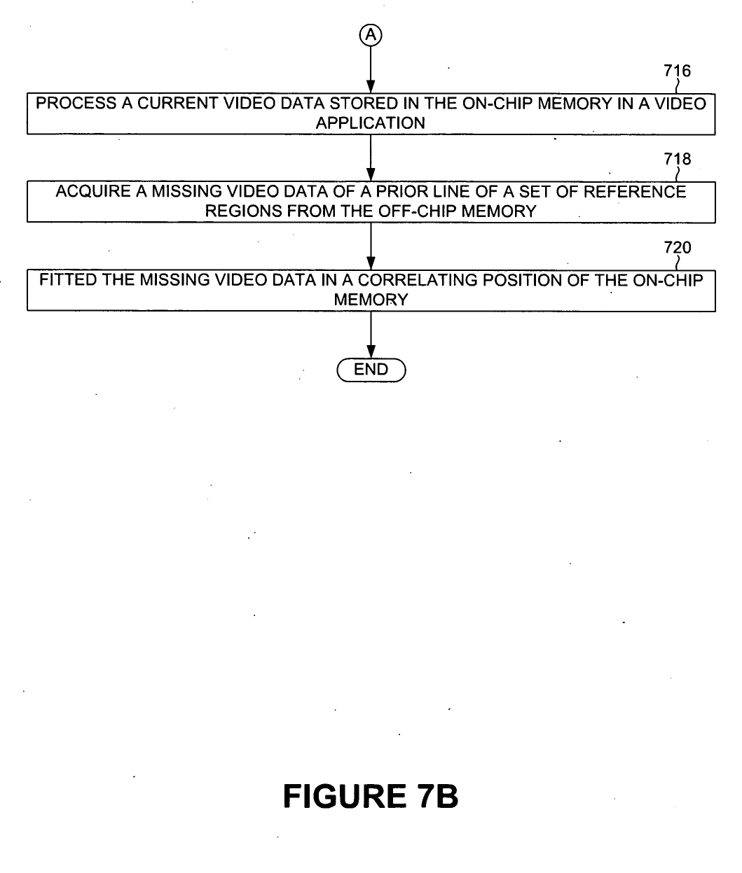

FIG. 7A is a process flow of processing a current video data stored in an on-chip memory (e.g., the on-chip memory 100 of FIG. 1) to apply the existing data to construct the next video data, according to one embodiment. In operation 702, a reusable portion of a preexisting video data (e.g., the preexisting video data 102 of FIG. 1) may be identified (e.g., using the video application module 600 of FIG. 6) in an on-chip memory (e.g., the on-chip memory 100 of FIG. 1) that corresponds to an overlapping video data (e.g., the overlapping video data 104 of FIG. 1) in an off-chip memory (e.g., the off-chip memory 406 of FIG. 4). In operation 704, the reusable portion of the preexisting video data 102 (e.g., as illustrated in FIG. 1) may be preserved (e.g., using the video application module 600 of FIG. 6) in the on-chip memory 100 (e.g., as illustrated in FIG. 1) in a reserved part of the on-chip memory 100 (e.g., as illustrated in FIG. 1).

In operation 706, the non-overlapping video data 108 (e.g., as illustrated in FIG. 1) (e.g., may exclude the overlapping video data) in the off-chip memory 406 (e.g., as illustrated in FIG. 4) may be determined (e.g., using the video application module 600 of FIG. 6). In operation 708, a subsection of the non-overlapping video data 108 (e.g., as illustrated in FIG. 1) may be defined (e.g., using the video application module 600 of FIG. 6). In operation 710, the subsection of the non-overlapping video data 108 (e.g., as illustrated in FIG. 1) may be accessed (e.g., using the video application module 600 of FIG. 6).

In operation 712, the subsection in the on-chip memory 100 (e.g., as illustrated in FIG. 1) may be selectively stored (e.g., using the video application module 600 of FIG. 6) (e.g., such that the reusable portion of the preexisting video data 102 (e.g., as illustrated in FIG. 1) of the on-chip memory 100 (e.g., as illustrated in FIG. 1) may be preserved in the reserved part of the on-chip memory 100 (e.g., as illustrated in FIG. 1). In operation 714, a coordinate of the reusable portion of the preexisting video data 102 (e.g., as illustrated in FIG. 1) in the on-chip memory 100 (e.g., as illustrated in FIG. 1) may be mapped (e.g., using the video application module 600 of FIG. 6), to correspond to the coordinate of the overlapping video data 104 (e.g., as illustrated in FIG. 1) in an off-chip memory 406 (e.g., as illustrated in FIG. 4).

FIG. 7B is a continuation of the process flow of FIG. 7A, illustrating additional processes, according to one embodiment. In operation 716, a new reusable portion of a current video data in the on-chip memory 100 (e.g., as illustrated in FIG. 1) may be identified, (e.g., using the video application module 600 of FIG. 6), that corresponds to an additional overlapping video data (e.g., as illustrated in FIG. 1) in the off-chip memory 406 (e.g., as illustrated in FIG. 4). In operation 718, the coordinate of the subsection selectively stored (e.g., using the video application module 600 of FIG. 6), in the on-chip memory100 (e.g., as illustrated in FIG. 1) may be mapped (e.g., using the video application module 600 of FIG. 6), to correspond to the coordinate of the subsection in the off-chip memory 406 (e.g., as illustrated in FIG. 4).

The subsection of the non-overlapping video data 108 (e.g., as illustrated in FIG. 1) in the off-chip memory 406 (e.g., as illustrated in FIG. 4) may be comprised of a rectangular region of the non-overlapping video data 108 (e.g., as illustrated in FIG. 1). The subsection of a transferable video data may be selectively stored (e.g., using the video application module 600) in an unreserved part of the on-chip memory 100 (e.g., as illustrated in FIG. 1) such that a coordinate of the subsection may correspond to a coordinate of the preexisting video data 500 (e.g., as illustrated in FIG. 5) preserved in the reserved part of the on-chip memory 100 (e.g., as illustrated in FIG. 1).

The continuing part of the selectively stored subsection that extends past a boundary may be selectively stored (e.g., using the video application module 600 of FIG. 6), at a beginning of an opposite boundary. The overlapping video data 104 (e.g., as illustrated in FIG. 1) in the off-chip memory 406 (e.g., as illustrated in FIG. 4) may be the same as the portion of the preexisting video data 500 (e.g., as illustrated in FIG. 5) in the on-chip memory 100 (e.g., as illustrated in FIG. 1). In operation 720, the current video data stored in the on-chip memory 100 (e.g., as illustrated in FIG. 1) in a video application may be processed. The video application may be a motion compensation module 602 (e.g., the motion compensation module 602 of FIG. 6) and a motion estimation module 604 (the motion estimation module 604 of FIG. 6).

The reference region in the off-chip memory 504 (e.g., as illustrated in FIG. 5) may be comprised by the overlapping video data 104 (e.g., as illustrated in FIG. 1) and the non-overlapping video data 108 (e.g., as illustrated in FIG. 1). The motion compensation window may be comprised of the preexisting video data 500 (e.g., as illustrated in FIG. 5) in the on-chip memory 100 (e.g., as illustrated in FIG. 1) and a next sequential motion compensation window may be comprised of the reference region 106 (e.g., as illustrated in FIG. 1) in the off-chip memory 406 (e.g., as illustrated in FIG. 4). The preexisting video data 500 (e.g., as illustrated in FIG. 5) in the on-chip memory 100 (e.g., as illustrated in FIG. 1) may be comprised of the motion compensation window from a prior line of motion compensation windows, and the next sequential motion compensation window may be comprised of the reference region 106 (e.g., as illustrated in FIG. 1) in the off-chip memory 406 (e.g., as illustrated in FIG. 4).

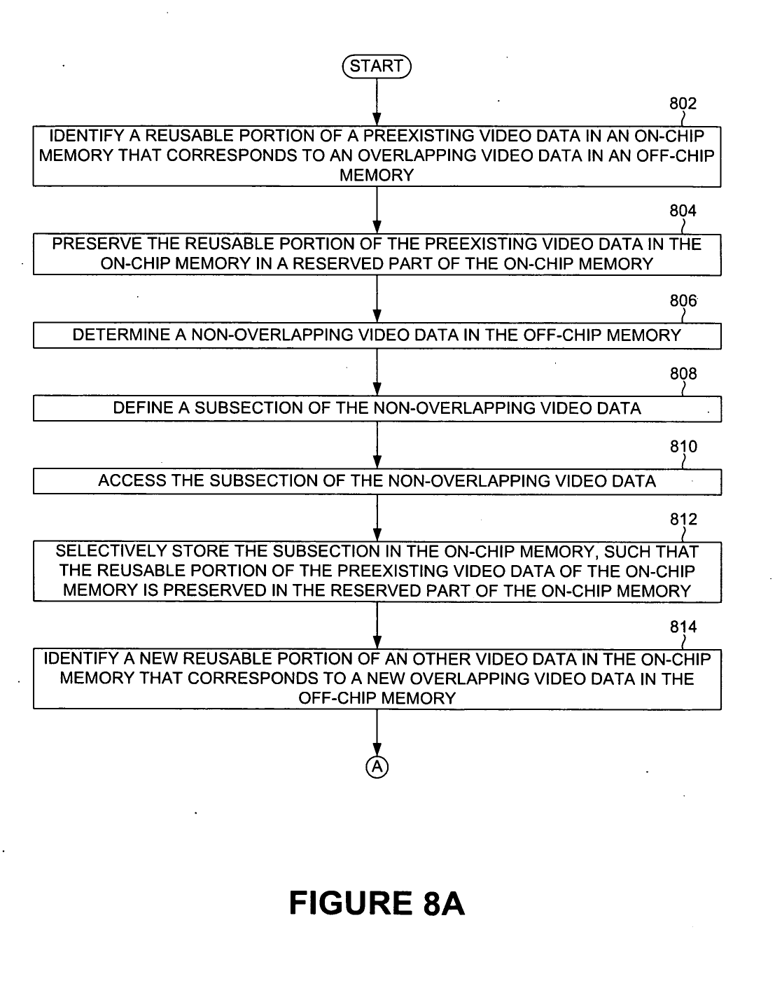

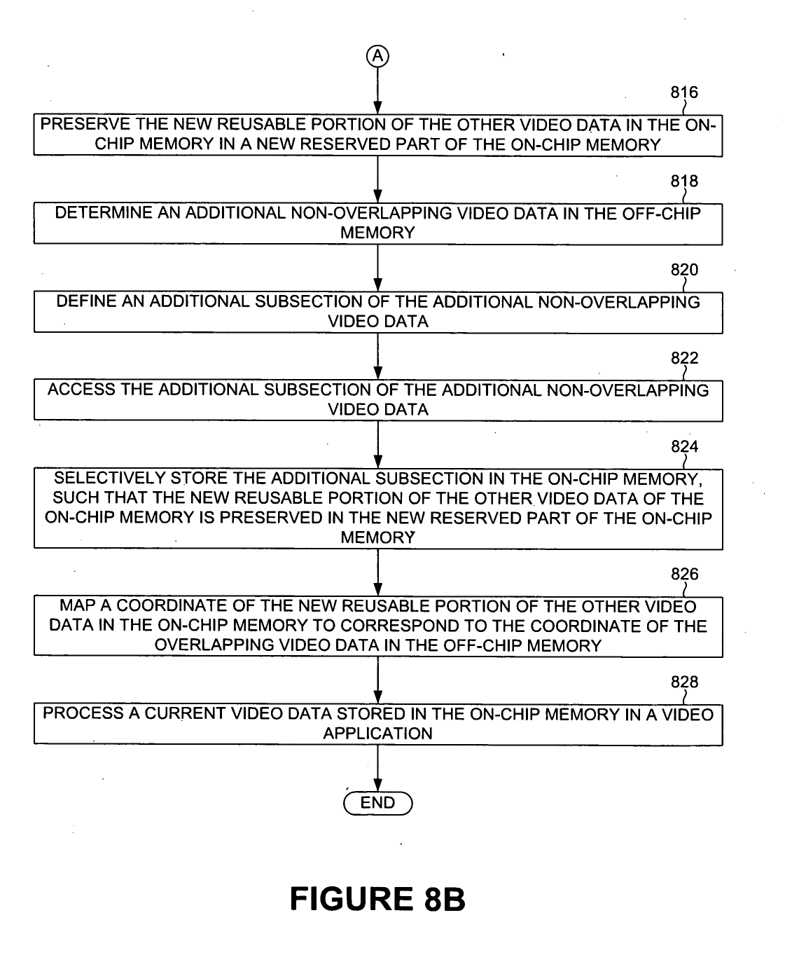

FIG. 8A is the process flow of identifying and processing the reusable video data stored in an on-chip memory (e.g., the on-chip memory 100 of FIG. 1), according to one embodiment. In operation 802, a reusable portion of a preexisting video data 102 (e.g., as illustrated in FIG. 1) in an on-chip memory (e.g., the on-chip memory 100 of FIG. 1) may be identified (e.g., using the video application module 600 of FIG. 6), that may correspond to an overlapping video data 104 (e.g., as illustrated in FIG. 1) in an off-chip memory (e.g., the off-chip memory 406 of FIG. 4). In operation 804, the reusable portion of the preexisting video data 102 (e.g., as illustrated in FIG. 1) in the on-chip memory 100 (e.g., as illustrated in FIG. 1) may be preserved (e.g., using the video application module 600 of FIG. 6), in a reserved part of the on-chip memory.

In operation 806, the non-overlapping video data 108 (e.g., as illustrated in FIG. 1) (e.g., that may excludes the overlapping video data) in the off-chip memory 406 (e.g., as illustrated in FIG. 4) may be determined (e.g., using the video application module 600 of FIG. 6). In operation 808, a subsection of the non-overlapping video data 108 (e.g., as illustrated in FIG. 1) data may be defined (e.g., using the video application module 600 of FIG. 6). In operation 810, a subsection of the non-overlapping video data 108 (e.g., as illustrated in FIG. 1) may be accessed (e.g., using the video application module 600). In operation 812, the subsection in the on-chip memory 100 (e.g., as illustrated in FIG. 1) may be selectively stored (e.g., using the video application module 600 of FIG. 6), such that the reusable portion of the preexisting video data 500 (e.g., as illustrated in FIG. 5) of the on-chip memory 100 (e.g., as illustrated in FIG. 1) may be preserved (e.g., using the video application module 600 of FIG. 6) in the reserved part of the on-chip memory 100 (e.g., as illustrated in FIG. 1).

In operation 814, a new reusable portion of an other video data (e.g., the new reusable portion of an other video data 402 of FIG. 4) in the on-chip memory may be identified (e.g., using the video application module 600 of FIG. 6), that corresponds to an additional overlapping video data (e.g., the additional overlapping video data 408 of FIG. 4) in the off-chip memory 406 (e.g., as illustrated in FIG. 4).

FIG. 8B is a continuation of the process flow of FIG. 8A illustrating additional process, according to one embodiment. In operation 816, the new reusable portion of the other video data 402 (e.g., as illustrated in FIG. 4) in the on-chip memory 100(e.g., as illustrated in FIG. 1) may be preserved (e.g., using the video application module 600 of FIG. 6), in a new reserved part of the on-chip memory 100 (e.g., as illustrated in FIG. 1). In operation 818, the additional non-overlapping video data (e.g., as illustrated in FIG. 1) (may exclude a new overlapping video data) in the off-chip memory 406 (e.g., as illustrated in FIG. 4) may be determined (e.g., using the video application module 600 of FIG. 6).

In operation 820, an additional subsection (e.g., the additional subsection 410 of FIG. 4) of a new non-overlapping video data may be defined (e.g., using the video application module 600 of FIG. 6). In operation 822, the additional subsection 410 (e.g., as illustrated in FIG. 4) of the new non-overlapping video data may be accessed (e.g., using the video application module 600 of FIG. 6). In operation 824, the additional subsection 410 (e.g., as illustrated in FIG. 4) in the on-chip memory 100 (e.g., as illustrated in FIG. 1) may be selectively stored (e.g., using the video application module 600 of FIG. 6), such that the new reusable portion of the other video data 402 (e.g., as illustrated in FIG. 4) of the on-chip memory 100 (e.g., as illustrated in FIG. 1) is preserved (e.g., using the video application module 600 of FIG. 6) in the new reserved part of the on-chip memory 100 (e.g., as illustrated in FIG. 1).

In operation 826, a coordinate of the new reusable portion of the other video data 402 (e.g., as illustrated in FIG. 4) in the on-chip memory 100 (e.g., as illustrated in FIG. 1) may be mapped (e.g., using the video application module 600 of FIG. 6) to correspond to the coordinate of the overlapping video data 104 (e.g., as illustrated in FIG. 1) in the off-chip memory 406 (e.g., as illustrated in FIG. 4). The continuing part of the selectively stored (e.g., using the video application module 600 of FIG. 6) subsection that extends past a boundary may be selectively stored at a beginning of an opposite boundary. In operation 828, a current video data stored in the on-chip memory 100 (e.g., as illustrated in FIG. 1) may be processed (e.g., using a processor 606 in a video application). The video application may be a motion compensation module 602 and a motion estimation module 604.

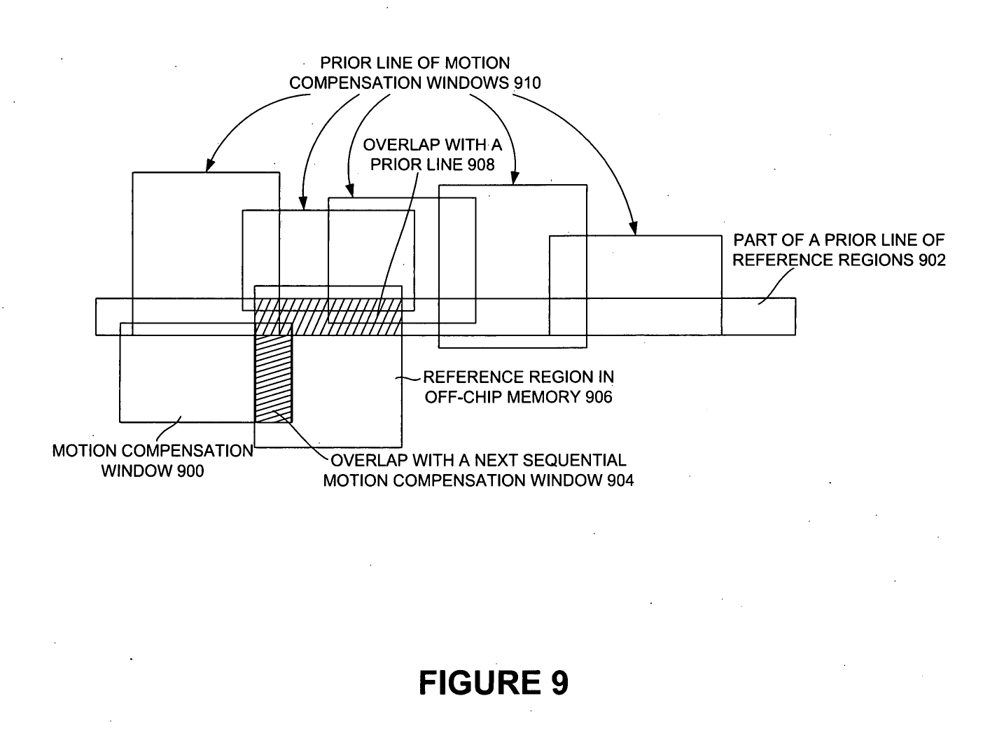

FIG. 9 is a systematic view of overlapping of a motion compensation window with a next sequential motion compensation window and with the selected portion of a prior line of reference regions, according to one embodiment. Particularly, FIG. 9 illustrates a motion compensation window 900, a part of a prior line of reference regions 902, an overlap with a next sequential motion compensation window 904, a reference region in off-chip memory 906, and an overlap with a prior line 908, according to one embodiment.

The motion compensation window 900 may be a portion of a preexisting video data 500 in the on-chip memory 100. The part of a prior line of reference regions 902 may be an additional portion of a preexisting video data 500 in the on-chip memory 100. The part of a prior line of reference regions 902 may include video data from a prior line of motion compensation windows 910. The part of a prior line of reference regions 902 may include additional video data put into on-chip memory 100 that was not included in a prior line of motion compensation windows 910. A separate access and storage action may be used to place the additional video data into the on-chip memory 100. The prior line of reference regions may be a series of reference regions that the motion compensation windows are taken from.

The reference region in off-chip memory 906 (e.g., of the video data) may be an area (e.g., bounding box) in the storage device (e.g., the off-chip memory 406) that may include data frames (e.g., video frames, etc.) comprised of the overlapping video data 104 and the non-overlapping video data 108 (e.g., portion of bounding box that may be used as part of constructing a next set of reference data). The reference region in off-chip memory 906 may be the region located in the off-chip memory (e.g., SRAM, DRAM, SDRAM, etc.) that may include the overlapping of the motion compensation window 900 with a next sequential motion compensation window. The overlap with a next sequential motion compensation window 904 may be a portion that may be obtained by overlapping the motion compensation window 900 with a next sequential motion compensation window of the reference region in the off-chip memory 406.

The reference region in off-chip memory 906 may be a region (e.g., of the video data) in the off-chip memory 406 that may include overlapping data with the preexisting video data 500 (e.g., in the on-chip memory), and both the reference region in off-chip memory 906 and the overlapping data with the preexisting video data 500 may be employed to refer to the change in the motion of the video data. The overlap with a prior line 908 may be a part of a prior line of reference regions 902 that may overlap with the reference region in off-chip memory 906.

In an example embodiment, the motion compensation window 900 of the preexisting video data may overlap with the next sequential motion compensation window 904 and with a part of a prior line of reference regions 902. The part of a prior line of reference regions 902 may be stored in a specific memory location that may be used by the processor 606 to construct the video data including the non-overlapping data.

In an additional example embodiment, a subsection 110 of the non-overlapping video data may be compared with the part of the prior line of reference regions 902 to identify an overlap with a prior line 908. The overlap with a prior line 908 may then be preserved in a reserved section of the on-chip memory 100 (e.g., a line buffer memory). Each additional subsection 110 of the non-overlapping video data may also be compared with the part of the prior line of reference regions 902 to identify an overlap with a prior line 908.

In a further example embodiment, the part of the prior line of reference regions 902 may have varying forms, and may be broken up into multiple parts. In addition, the part of the prior line of reference regions 902 may have an upper edge and a lower edge that are determined based on a characteristic of the prior line of reference regions. The part of the prior line of reference regions 902 may further have an upper edge and a lower edge that are determined based on a characteristic of the prior line of motion compensation windows. In another embodiment, the position (e.g., a bottom edge position, a top edge position, etc.) and the form of the part of the prior line of reference regions 902 that is stored in on-chip memory may be determined by finding a global motion (e.g., an average motion) within a previous frame to determine a preferred lower. Multiple characteristics of the video information processed by the encoder may be used to determine the position and the form of the part of the prior line of reference regions 902 stored in an on-chip memory.

In another embodiment, multiple characteristics of the video information processed by the encoder may be used to determine whether the part of the prior line of reference regions 902 should be stored in an on-chip memory. If a line buffer is not filled, then only horizontal overlap detection method can be used by a next row of bounding boxes. For example, in one embodiment, a characteristic of the video information may be a number of intra blocks encountered in a row of macro-blocks, which may be used to determine that the line buffer should stop being filled if the number of intra blocks exceeds a threshold number. In another embodiment, a frame level decision may be made which uses the statistic from a previous frame to decide to enable or disable the line buffer for a current frame.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the video application module 600, the motion compensation module 602, the motion estimation module 604, and other modules of FIG. 1 to 8 may be enabled using software and/or using transistors, logic gates, and electrical circuits (e.g., application specific integrated ASIC circuitry) like a video application circuit, a motion compensation circuit, a motion estimation circuit, the on-chip memory 100, the off-chip memory 406, the processor 606, and other circuits.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
identifying a reusable portion of a preexisting video data in an on-chip memory that corresponds to an overlapping video data in an off-chip memory;
preserving the reusable portion of the preexisting video data in the on-chip memory in a reserved part of the on-chip memory;
determining a non-overlapping video data in the off-chip memory, wherein the non-overlapping video data excludes the overlapping video data in the off-chip memory; and
selectively storing a subsection of the non-overlapping video data in the on-chip memory while preserving the reusable portion of the preexisting video data.

2. The method of claim 1 further comprising mapping a coordinate of the reusable portion of the preexisting video data in the on-chip memory to correspond to the coordinate of the overlapping video data in the off-chip memory.

3. The method of claim 2 further comprising identifying a new reusable portion of a current video data in the on-chip memory that corresponds to an additional overlapping video data in the off-chip memory.

4. The method of claim 2 further comprising mapping the coordinate of the subsection selectively stored in the on-chip memory to correspond to the coordinate of the subsection in the off-chip memory.

5. The method of claim 4 wherein the subsection of the non-overlapping video data in the off-chip memory is comprised of a rectangular region of the non-overlapping video data.

6. The method of claim 5 wherein the subsection of the non-overlapping video data is selectively stored in an unreserved part of the on-chip memory such that a coordinate of the subsection corresponds to a coordinate of the preexisting video data preserved in the reserved part of the on-chip memory.

7. The method of claim 6 wherein a continuing part of a selectively stored subsection that would extend past a boundary is selectively stored at a beginning of an opposite boundary.

8. The method of claim 7 wherein the overlapping video data in the off-chip memory is the same as the reusable portion of the preexisting video data in the on-chip memory.

9. The method of claim 8 further comprising processing a current video data stored in the on-chip memory in a video application, wherein the video application is at least one of a motion compensation module and a motion estimation module.

10. The method of claim 9 wherein a reference region in the off-chip memory is comprised of the overlapping video data and the non-overlapping video data.

11. The method of claim 10 wherein the preexisting video data in the on-chip memory is comprised of a motion compensation window and the reference region in the off-chip memory is comprised of a next sequential motion compensation window.

12. The method of claim 10 wherein the preexisting video data in the on-chip memory is comprised of a selected portion of a prior line of reference regions.

13. The method of claim 12 further comprising:
acquiring a missing video data of a prior line of a set of reference regions from the off-chip memory; and
fitting the missing video data in a correlating position of the on-chip memory.

14. The method of claim 10 wherein the overlapping video data is comprised of a part of a next sequential motion compensation window and an other part of a prior line of reference regions.

15. The method of claim 14 wherein selectively storing the subsection preserves an additional overlapping video data in the on-chip memory that corresponds to the other part of the prior line of reference regions.

16. A method comprising:
identifying a reusable portion of a preexisting video data in an on-chip memory that corresponds to an overlapping video data in an off-chip memory;
preserving the reusable portion of the preexisting video data in the on-chip memory in a reserved part of the on-chip memory;
determining a non-overlapping video data in the off-chip memory, wherein the non-overlapping video data excludes the overlapping video data in the off-chip memory;
defining a subsection of the non-overlapping video data;
accessing the subsection of the non-overlapping video data;
selectively storing the subsection in the on-chip memory, such that the reusable portion of the preexisting video data of the on-chip memory is preserved in the reserved part of the on-chip memory; and
identifying a new reusable portion of an other video data in the on-chip memory that corresponds to a new overlapping video data in the off-chip memory.

17. The method of claim 16 further comprising:
preserving the new reusable portion of the other video data in the on-chip memory in a new reserved part of the on-chip memory;
determining an additional non-overlapping video data in the off-chip memory, wherein the additional non-overlapping video data excludes the new overlapping video data in the off-chip memory;
defining an additional subsection of the additional non-overlapping video data;
accessing the additional subsection of the additional non-overlapping video data; and
selectively storing the additional subsection in the on-chip memory, such that the new reusable portion of the other video data of the on-chip memory is preserved in the new reserved part of the on-chip memory.

18. The method of claim 17 further comprising:
mapping a coordinate of the new reusable portion of the other video data in the on-chip memory to correspond to the coordinate of the overlapping video data in the off-chip memory, and wherein a continuing part of the subsection and the additional subsection that extends past a boundary is selectively stored at a beginning of an opposite boundary; and
processing a current video data stored in the on-chip memory in a video application, wherein the video application is at least one of a motion compensation module and a motion estimation module.

19. A system comprising:
a processor communicatively coupled to a memory and a storage device; and
a video application module associated with the processor to identify a reusable portion of a preexisting video data in an on-chip memory that corresponds to an overlapping video data in an off-chip memory, to preserve the reusable portion of the preexisting video data in the on-chip memory in a reserved part of the on-chip memory, to determine a non-overlapping video data in the off-chip memory, wherein the non-overlapping video data excludes the overlapping video data in the off-chip memory, to define a subsection of the non-overlapping video data, to access the subsection of the non-overlapping video data, and to selectively store the subsection in the on-chip memory, such that the reusable portion of the preexisting video data of the on-chip memory is preserved in the reserved part of the on-chip memory.

20. The system of claim 19 wherein the video application module is comprised of at least one of a motion compensation module and a motion estimation module.
